(19) United States
(12) Patent Application Publication
(10) Pub. No.: US 2025/0122629 A1
(43) Pub. Date: Apr. 17, 2025

(54) HYDROGEN AND ELECTRICAL POWER STORAGE

(71) Applicant: NovaSpark Energy, Inc., Ruston, LA (US)

(72) Inventors: Fredrick L. Harlow, Baytown, TX (US); Thomas Charles Barnett, JR., Monroe, LA (US)

(73) Assignee: NovaSpark Energy, Inc., Ruston, LA (US)

(21) Appl. No.: 18/913,533

(22) Filed: Oct. 11, 2024

Related U.S. Application Data
(60) Provisional application No. 63/589,371, filed on Oct. 11, 2023.

(51) Int. Cl. C25B 1/04; B60R 16/033; B60S 9/02; B62D 63/08; C25B 9/19; C25B 9/65; C25B 15/02; C25B 15/08; F17C 5/06

(52) U.S. Cl. CPC C25B 1/04; B60R 16/033; B60S 9/02; B62D 63/08; C25B 9/19; C25B 9/65; C25B 15/02; C25B 15/08; F17C 5/06; F17C 2205/0107; F17C 2221/012; F17C 2227/0157; F17C 2270/0171

(57) ABSTRACT

A mission configurable system for fuel generation is provided. The mission configurable system includes a mobility unit configured to support multiple fuel generation components customized to a specific mission. The fuel generation components can include at least one renewable energy generation system such as a hydrogen electrolyzer, a methane reformer, a solar panel, and/or a wind turbine.

### CROSS-REFERENCE TO RELATED APPLICATION

This application claims the benefit of priority of U.S. provisional application No. 63/589,371, filed Oct. 11, 2023, the contents of which are herein incorporated by reference.

### BACKGROUND OF THE INVENTION

The present invention relates to scalable renewable energy systems and, more particularly, to modular hydrogen (H₂) energy generation and storage integrated with renewable energy production modules.

Consumer demand for mobile and remote on-site H₂ generation and energy storage has been steadily growing. Consumers increasingly choose green energy sources for their mobility and fixed energy needs. As such, there is a growing need to link the availability of H₂ Fueling with Electric Fueling locations to provide a unified fueling means that supports the growth of the H₂ and electric vehicle (EV) markets. Tied to this growing mobility usage is the use of H₂ to provide Micro-grid power for residences and businesses alike. Moreover, the vast majority of current H₂ delivery utilizes a supply chain focused on over-the-road shipping or pipelines to deliver H₂ to fueling stations or user end points. Thus, the limited availability of disparate H₂ and Electrical fueling means driven by supply chain limitations is no longer adequate for consumer needs. To accommodate these changing demands, the service infrastructure and functionality of H₂ generation and fueling systems must be pushed closer to the consumer and distributed across consumer locations by bypassing traditional distribution channels.

A service provider typically connects to an existing alternating current (AC) power grid via costly transformers and other interconnect means. Access to the AC power grid infrastructure relies on the placement of power cables to these locations, thus limiting placement of H₂ generation systems. These techniques are too costly to sustain and adapt across diverse future energy deployment needs. Most current green energy delivery relies heavily on large and costly battery technology to store energy.

As can be seen, there is a need for a scalable H₂ generation platform that can be used in mobile and fixed architectures that combines H₂ generation and energy storage for use in H₂ Fueling, Electric Fueling and Micro-grid Power.

### SUMMARY OF THE INVENTION

In one aspect of the present invention, a modular mobile hydrogen generation platform comprises a frame; a hydrogen generator mounted within the frame, wherein the hydrogen generator is selected from the group consisting of one or more electrolyzers; one or more reformers; and any combination thereof; a hydrogen storage system mounted within the frame and fluidly communicating with the hydrogen generator and configured to receive hydrogen generated by the hydrogen generator; a pneumatic power system mounted within the frame; an electrical power source mounted within the frame and electrically coupled to the hydrogen generator; and a controller.

The system disclosed herein includes an atmospheric hydrogen generator that extracts water from the air to produce energy, powering electricity, vehicles, drones, and industrial applications. This scalable, off-grid solution serves both military and commercial needs

These and other features, aspects and advantages of the present invention will become better understood with reference to the following drawings, description, and claims.

### BRIEF DESCRIPTION OF THE DRAWINGS

FIG. 1A is a schematic view of a self-sustaining, trailer-based mobile H₂ production and/or fueling apparatus for use at remote locations according to an embodiment of the present invention;

FIG. 1B is a side elevation view of a self-sustaining, trailer-based mobile H₂ production and/or fueling apparatus for use at remote locations according to another embodiment of the present invention;

FIG. 1C is a perspective schematic view of an electrolyzer-based H₂ generation system of the apparatus of FIG. 1A;

FIG. 1D is a perspective schematic view of an integrated reformer-based H₂ generation system of the apparatus of FIG. 1A;

FIG. 2 is a perspective schematic view of a self-sustaining, Palletized Load System (PLS)-based mobile H₂ fueling and electrical generation system according to an embodiment of the present invention;

FIGS. 3A, 3B, 3C1, 3C2, 3C3, 3D, 3E, 3F, 3G, 3H, 3J, 3K, 3L, and 3M are schematic diagrams of reconfigurable Operational System Packs (OSP) according to embodiments of the present invention; and

FIG. 4A, 4B, 4C, 4D, and 4E are flow charts of methods of operation according to embodiments of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a scalable, modular system of Operational System Pack(s) (OSPs) for implementing cost effective and disruptive H₂ generation platforms and energy storage for on-demand power.

Advantageously, the hydrogen generator of the present invention may be moved without emptying its contents due to modified venting, upgraded internal components including seals, and a modified sensing means for monitoring the seals. For example, an Anion Exchange Membrane electrolyzer generally contains potassium hydroxide. In contrast, currently available Anion Exchange Membrane electrolyzers are not safe to move without emptying potassium hydroxide from the unit. This allows use of the invention while it is in movement. For example, the electrolyzer(s) may be operated on a ship under way or on another mobile platform requiring hydrogen fuel production.

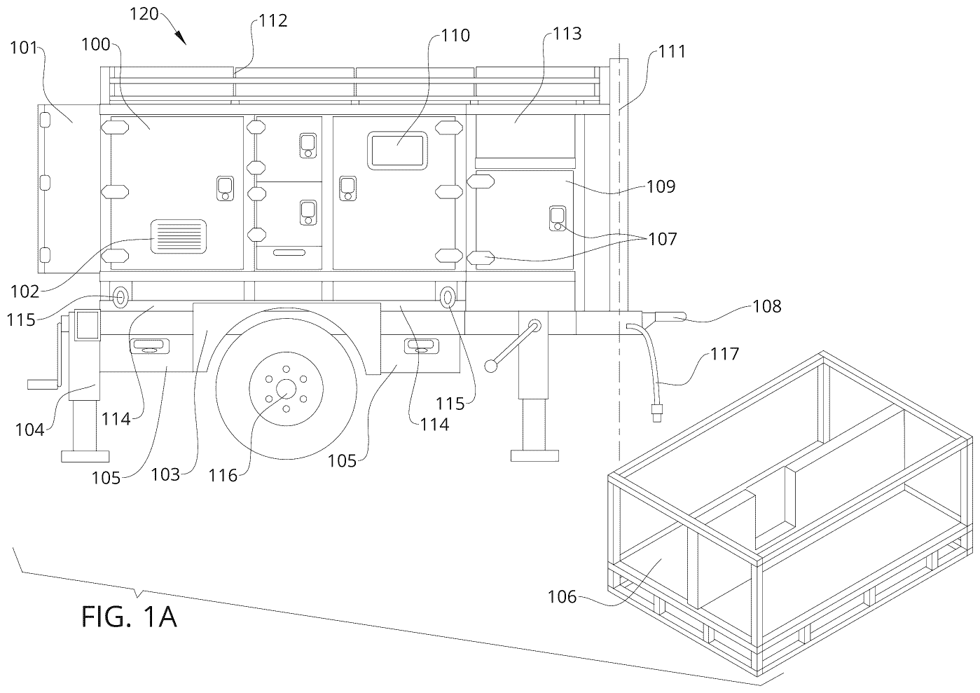

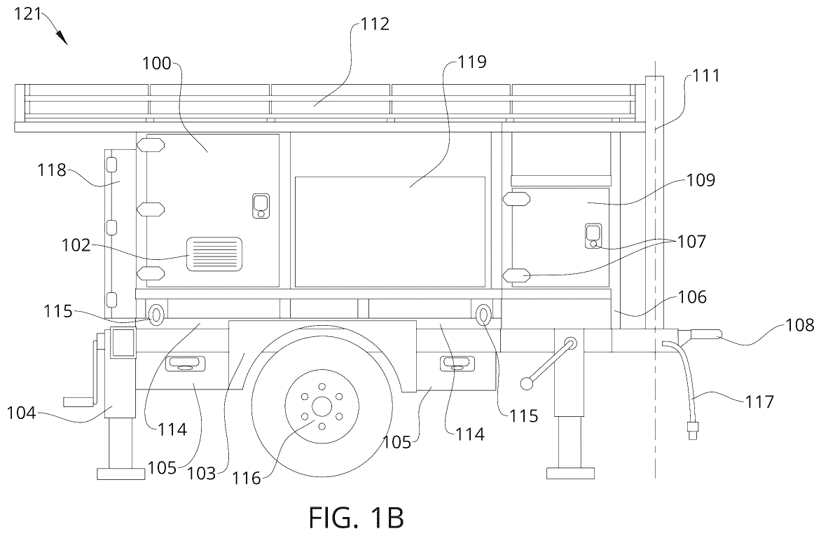

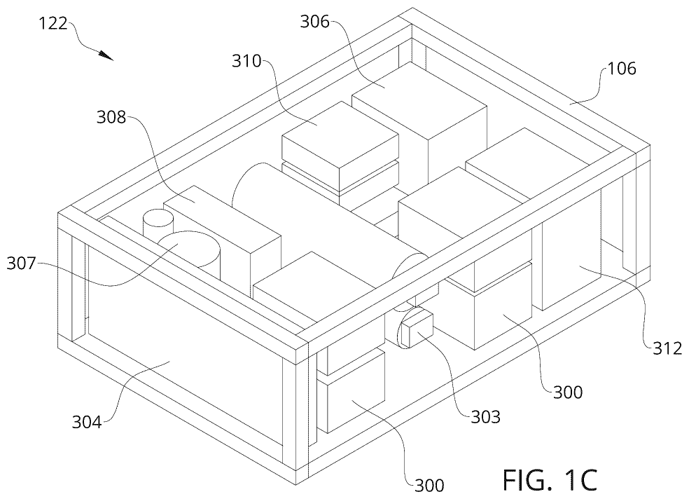

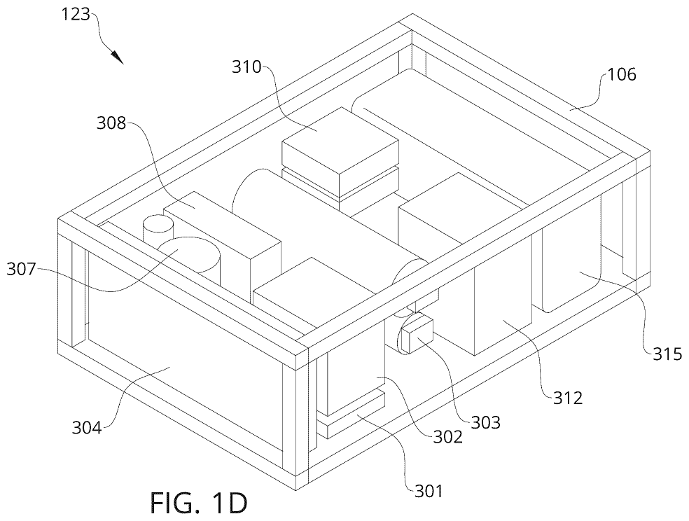

Referring to FIGS. 1A, 1B, 1C, 1D, 2, 3A, 3B, 3C1, 3C2, 3C3, 3D, 3E, 3F, 3G, 3H, 3J, 3K, 3L, 3M, 4A, 4B, 4C, 4D, and 4E, exemplary embodiments of various components and systems of the present invention are shown. The systems may include but are not limited to the elements and method steps shown in the Figures.

FIG. 1A depicts an Integrated Mobility Trailer 120 OSP (H₂-OSP-T). This OSP utilizes a standardized Trailer Package 103 that allows integration of various H₂-OSPs to build a complete platform. Trailer 120 is configured to accept a Standardized Main Structure or frame 106 that supports the deployment of multiple OSP configurations. The Main Structure 106 includes a Loadbearing Structural Frame to support the weight of the OSPs mounted in the Main Structure 106 as well as a photovoltaic (PV) Panel mounting system 112 and a Wind Turbine mast 111 that pivots flat with the PV panel frame for storage during movement. The frame 106 may have a wiring and/or piping chase, e.g., extending longitudinally down its centerline. The Main Structure 106 is also enclosed in an Ingress Protection (IP) 65 rated/National Electrical Manufacturer Association (NEMA) 3R rated cabinet/covering, enclosure, or housing 100 used to protect the OSPs and other equipment mounted/stored on the Main Structure 106 and trailer. The trailer 120 and/or the cabinet 100 may have drawers 105. Based on the OSP contained in the Main Structure 106, the Reconfigurable Cabinet doors 109 may contain a combination of Access Points/Interfaces 101, Air Filter 102, Digital/Analog Controls 110, Heat Exchangers 113, Locking Mechanisms 107, Insulation, and various interfaces and support systems required for the operation of the overall platform. The Trailer 120 also provides Quick Disconnect mounts 114 for the Main Structure 106 that allows removal from the trailer 120 for maintenance, ground placement or placement on another trailer such as a Joint Light Tactical Vehicle (JLTV) trailer. The trailer 120 supports standard Towing connections 108 such as Commercial Ball Mount and Pintle Based Towing Hooks along with Standard Safety Chains. Harness points 115 are provided on the trailer 120 to support Air Mobility of the loaded trailer 120. The trailer 120 utilizes a Single Solid Axle Suspension system or an Independent Suspension System 116 based on the intended use of the trailer 120. The axle location is adjustable in order to adjust the Tongue Weight and/or Center of Balance based on the various OSP configurations available. The trailer 120 also contains retractable Stabilization Mechanisms/Jacks 104 that are used to stabilize and/or level the system while in stationary use. The trailer 120 includes a light and control system 117 (including connectors) to allow licensing for over the road use as well as deployment in military tactical scenarios.

FIG. 1B depicts an alternate trailer 121 (H₂-OSP-TA) for multi-trailer configurations in support of ad hoc or on-demand deployment. The dual trailer system allows independent use of the H₂ Generation when the Renewable Energy system is not required (i.e., grid or generator power). The dual trailer system also supports a Customizable Mounting Space 119 configured to allow on-demand configurations using devices such as an independent generator, additional battery/super capacitor storage and/or Fuel Cell Power Systems on the Renewable Energy trailer. The trailers are interconnected from the H₂ and Power Interface Cabinet 118 using separate H₂ hardened hoses and power/control cables with pin and sleeve connectors.

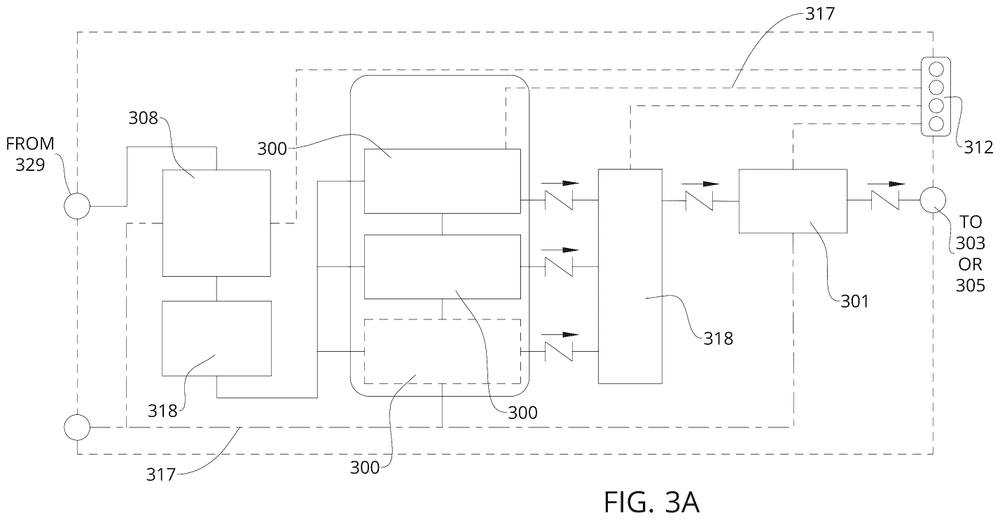

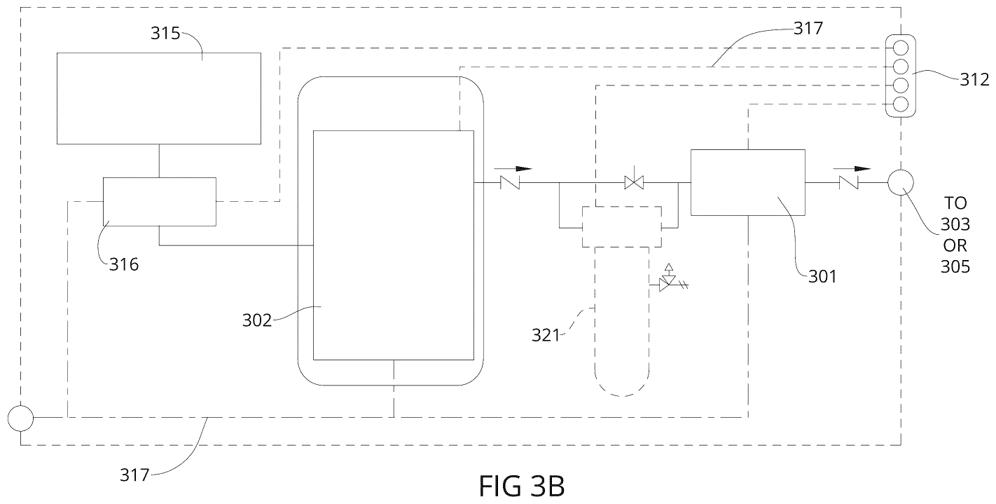

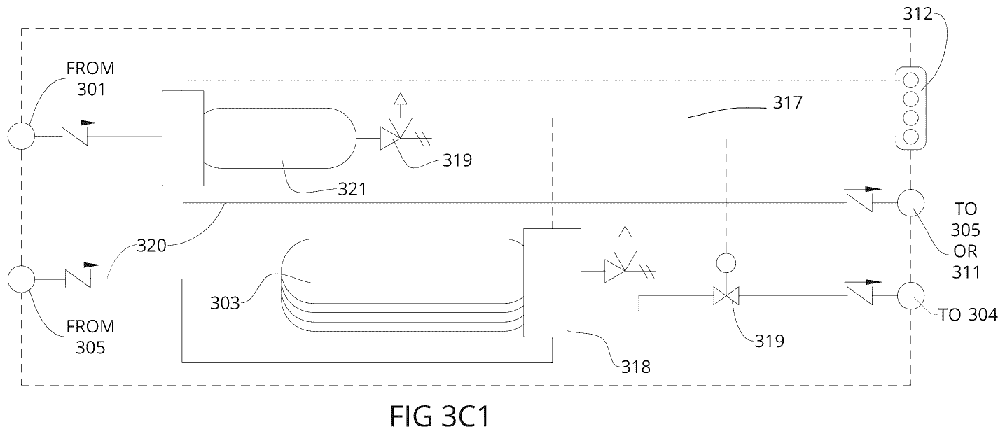

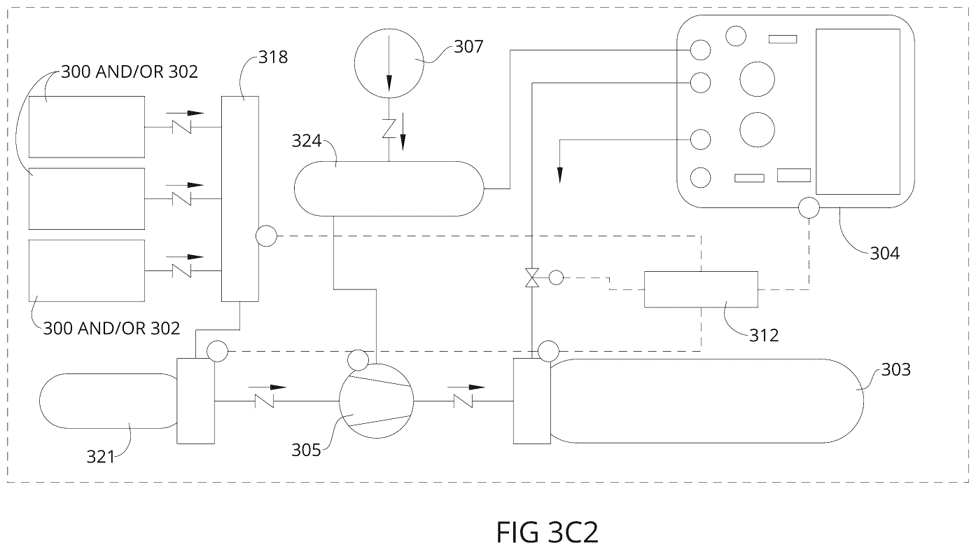

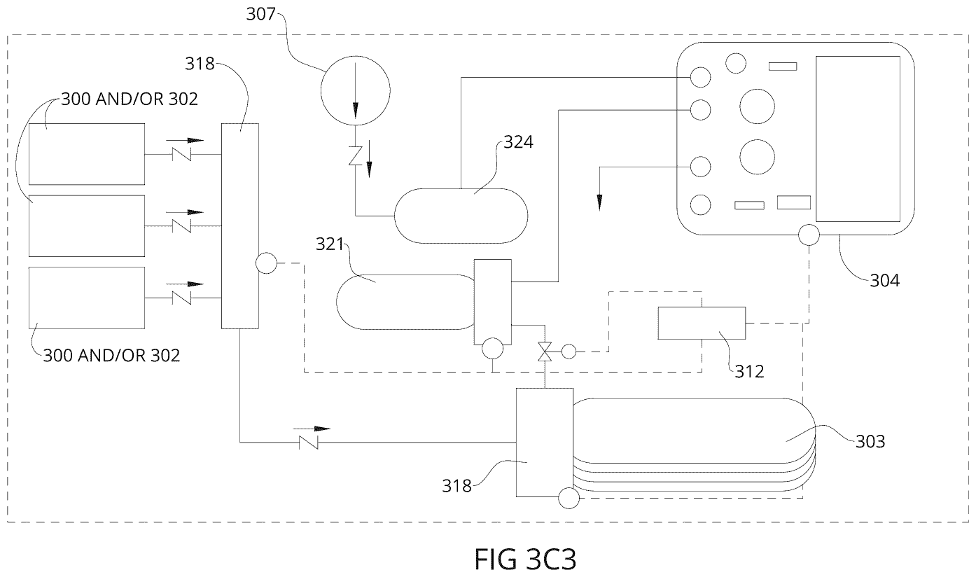

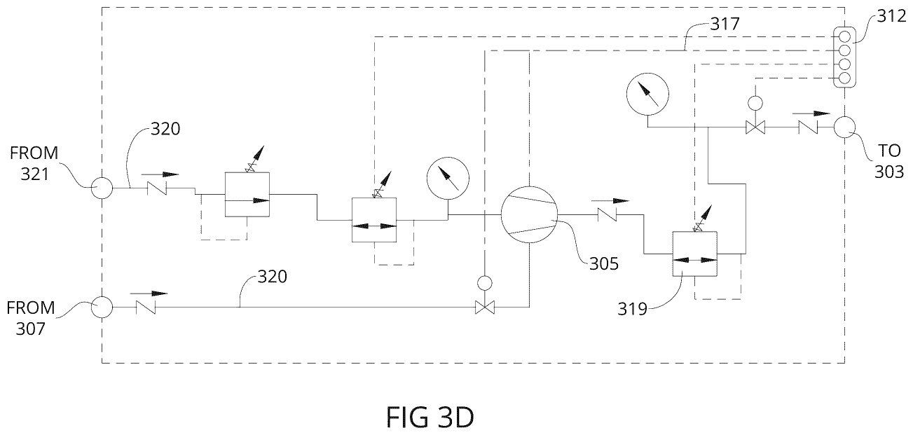

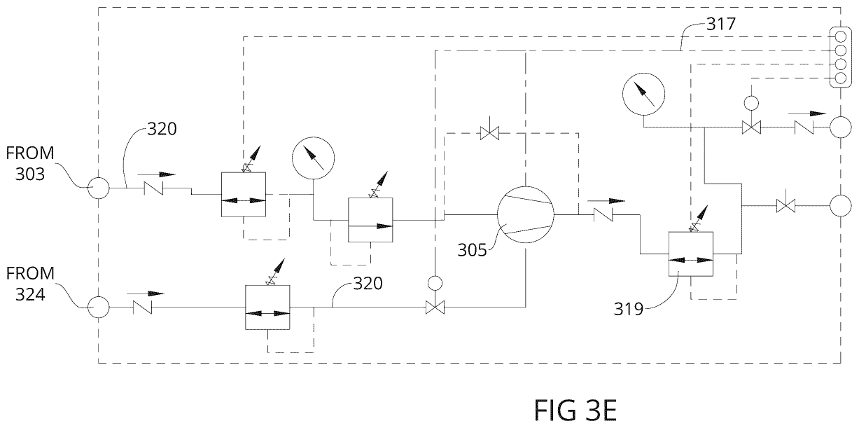

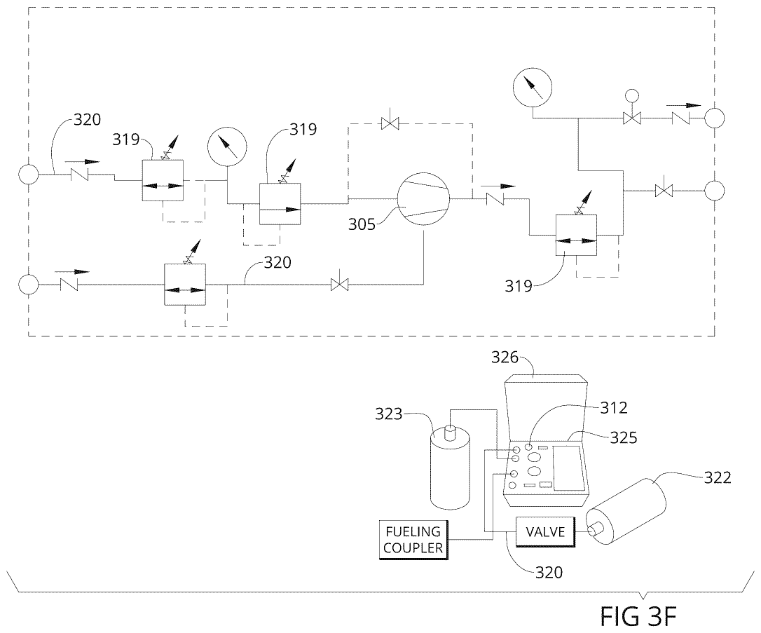

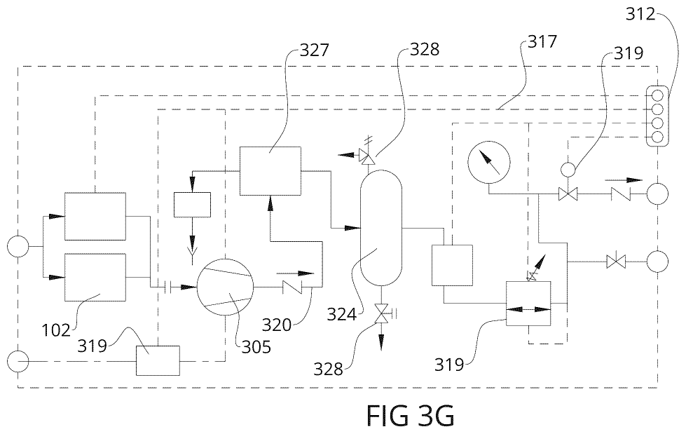

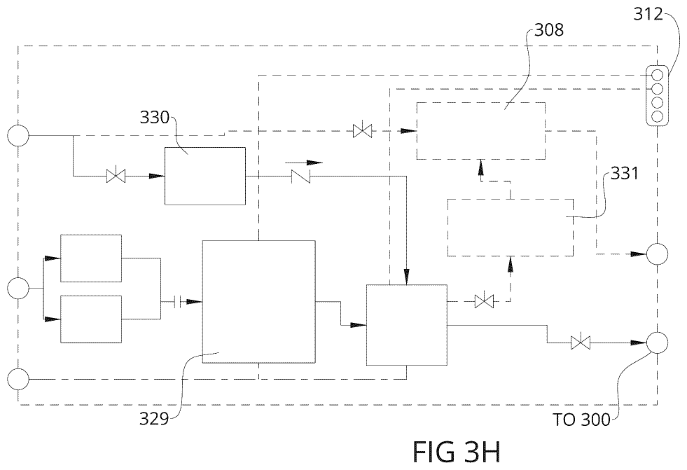

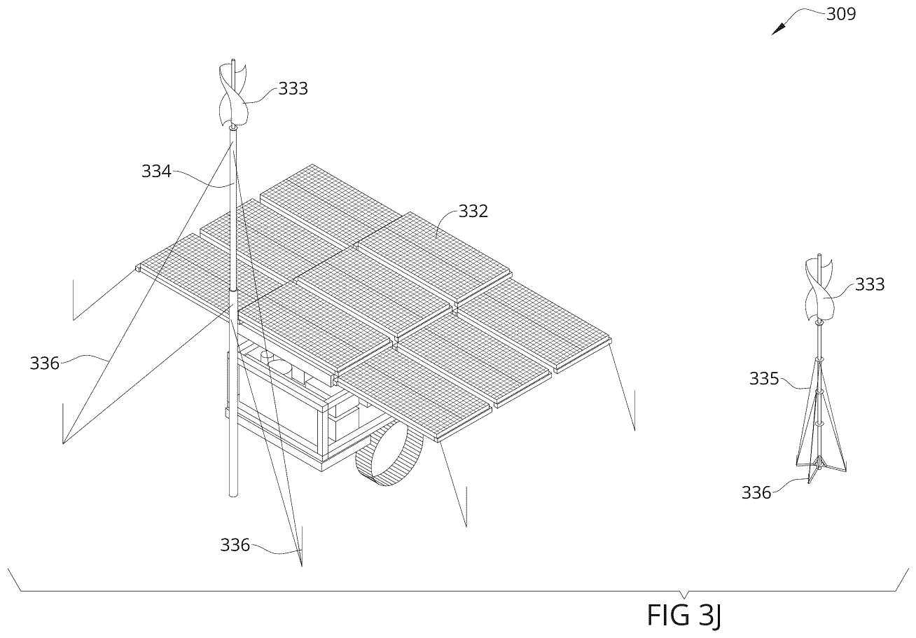

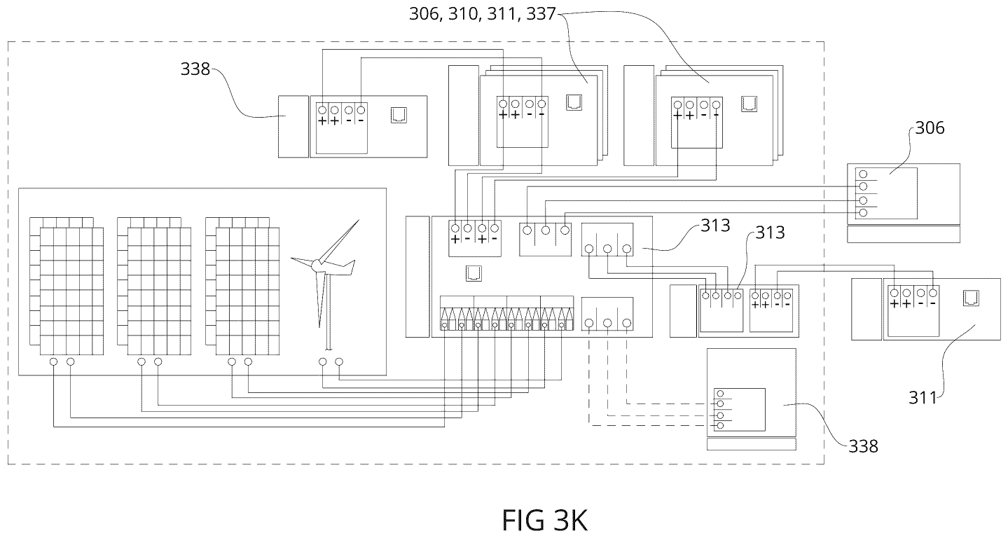

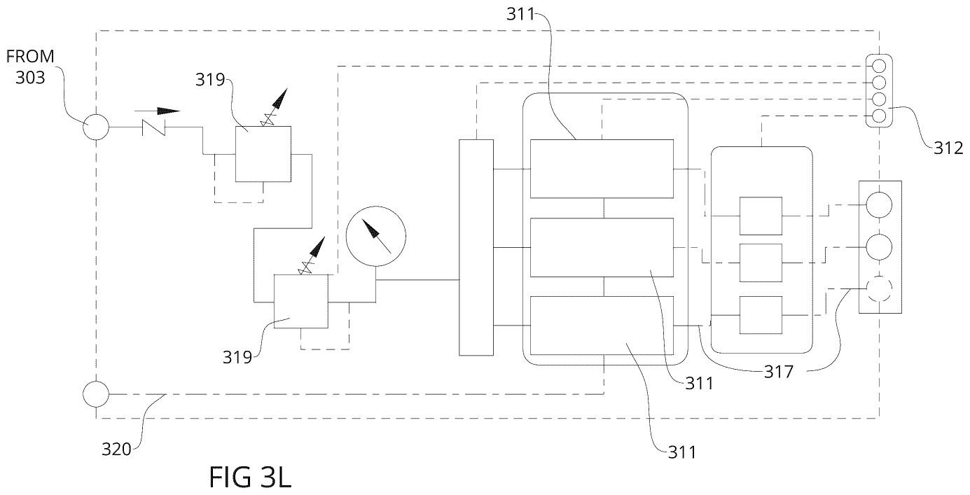

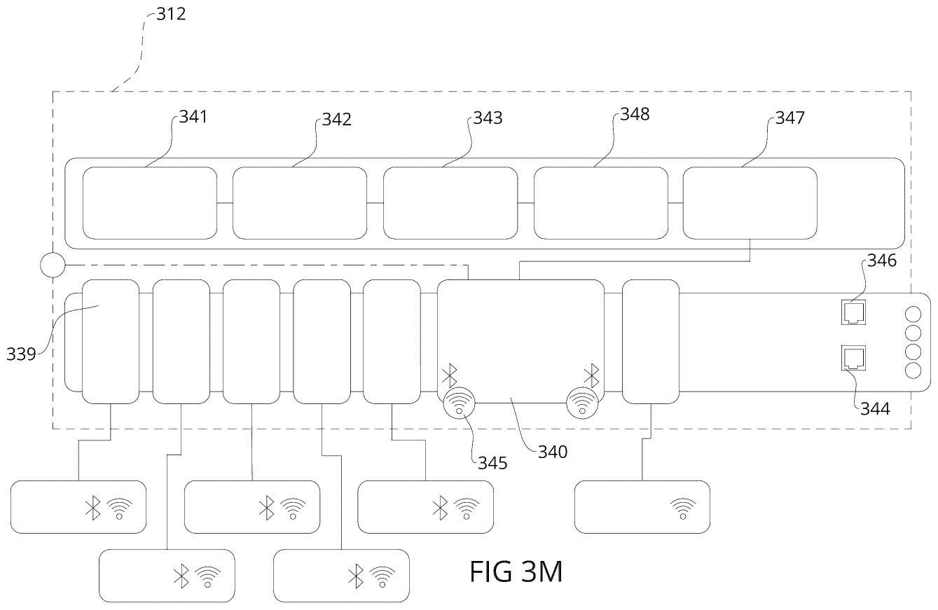

FIG. 1C illustrates an Integrated Electrolyzer Based H2 Generation system 122 for mounting on the Trailer 120 of FIG. 1A. The system 122 utilizes a plurality of Anion Exchange Membrane (AEM) or Proton Exchange Membrane (PEM) Electrolyzers 300 to generate H₂ in Combination with other OSP Packages. The electrolyzers 300 may be stacked one on another and/or the electrolyzers 300 may be stacked with one or more batteries 310 and/or a water tank 308. The system 122 uses a Water Generation System (see FIG. 3H) including water tanks 308 in support of electrolyzer operations. The system 122 includes a plurality of power sources that provide either Alternating Current (AC) or Direct Current (DC) electrical power for use in the process of electrolysis. In embodiments, the power sources include at least one of a portable generator 306 and/or one or more batteries 310. Additionally, one or more water tanks 308 is provided as a source for the electrolysis process. H₂ generated during the electrolysis process can be stored to one or more storage tanks 303, and/or provided directly as a fuel source through refueling panel 304. Refueling panel 304 provides access to compressed H₂, which is compressed by compressor 305 (see FIG. 3D), utilizing air tank 324 and pneumatics 307. Control of inputs, such as input power and water, and outputs, such as electrical power distribution, of system 122 can be controlled by controller 312. Additionally, the controller may include an inverter 313 to convert output electricity from Direct Current (DC) to Alternating Current (AC). (See also FIGS. 3J and 3L.)

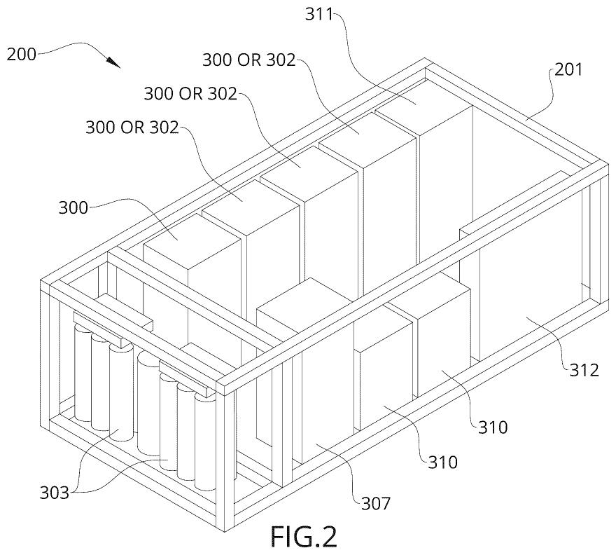

FIG. 1D shows an Integrated Reformer Based H2 Generation System 123 for mounting on the Trailer 120 of FIG. 1A. In this configuration, the system 123 can provide H₂ through a catalytic process to storage tanks 303 or directly for refueling. Refueling can be accomplished by providing H₂, compressed by compressor 305 (see FIG. 3D) utilizing air tank 324 and pneumatics 307, to one or more vehicles or other devices needing power. The system 123 can utilize a H₂ Reformer 302 (see FIG. 3B) and a 50 Gallon Methanol/deionized (DI) Feedstock Tank 315 to fuel the Reformer OSP Packages. An Integrated Reformer Based H₂ Generation System that utilizes the H₂ Reformer 302 will require use of the Trailer 121 of FIG. 1B or the PLS 200 of FIG. 2 to accommodate the larger Reformer as well as larger Feedstock Tanks. An H₂ dryer 301 can be disposed proximate to reformer 302 and can be configured to remove water from hydrogen through the Hydrogen-Oxygen reaction. For example, the dryer 301 and the reformer 302 may be stacked. System 123 includes a plurality of power sources, such as one or more batteries 310 for use in the reforming process. Control of inputs, such as input power and water, and outputs, such as electrical power distribution, of system 123 can be controlled by controller 312. Additionally, output electricity can be converted from Direct Current (DC) to Alternating Current (AC) by inverter 313 (found in controller 312). In some embodiments, the Water Generation OSP (see FIG. 3H) may provide Deionized Water for use with the Feedstock or top produce Potable Water.

FIG. 2 illustrates a Palletized Load System (PLS) Mobility Package (H₂-OSP-PLS) 200. The system 200 utilizes a Hook Loaded Palletized Load System or Roll On/Roll Off transport vehicle. The system 200 is focused on support for remote fueling operations such as Heavy Duty unmanned aerial vehicle (UAV)/Drone/Light Aircraft fueling, Fuel Cell Vehicle fueling, H₂ generation for Fuel Cell powered Electrical Generators, Fuel Cell powered Micro-grids, or other similar use cases. The system 200 includes a plurality of components disposed within a container 201, where it is contemplated that the system 200 can utilize 10 ft. and 16 ft. International Organization for Standardization (ISO) Containers that support larger OSP configurations and maintain mobility of the system 200. Although lower powered configurations can fit in a single 16 ft. ISO Containers 201, systems above 70 KW can utilize dual 10 ft. ISO Containers or a combination of 10 ft. and 16 ft. ISO Containers. In this case, one ISO container to support the H₂ Generation system and a second ISO Container to support the additional weight of the larger Battery Storage system and/or larger Reformer Feedstock requirements. Advantageously, the dual ISO Containers also better support mounting requirements for the larger Renewable Energy System (PV and Wind Turbine systems 309) required for the higher power means.

The components of system 200 are configured to generate 30 to 150 KW of power through various OSPs. In embodiments, one or more storage tanks 303 are disposed in container 201 and are configured to store H₂ generated during electrolysis. The system 200 can include a plurality of OSPs, in parallel, such as at least one Anion Exchange Membrane (AEM) or Proton Exchange Membrane (PEM) Electrolyzer 300 with refueling panel 304 and water tank 308 (see FIGS. 1C and 1D), and one or more of an additional AEM or PEM Electrolyzer 300, or a Reformer 302 with dryer stack. Additionally, one or more power sources such as a fuel cell 311 and one or more batteries or supercapacitors 310 can be provided to generate power for use in electrolysis. System 200 inputs, functionality and outputs can be controlled by one or more controllers 312. Finally, output electricity can be converted from Direct Current (DC) to Alternating Current (AC) by inverter 313 (found in controller 312).

FIG. 3A depicts an Electrolyzer H2 Generation OSP (H₂-OSP-E) comprising one or more Anion Exchange Membrane (AEM) Electrolyzer 300 and/or Proton Exchange Membrane (PEM) Electrolyzer 300 units, at least one H2 Dryer 301, mounting cage(s), control valves 319, electrical wiring 317 using hardened connectors for power and control signals, a Deionized Water Tank 308 with a manifold 318, and associated piping 320. The electrical wiring 317 delivers AC and/or DC power obtained from a power source to a deionized water tank 308, the electrolyzers 300, and the hydrogen dryer 301. The electrolyzers 300 may be contained within environmental controls, controlling, for example, airflow and oxygen venting.

In embodiments, water is generated by one or more atmospheric water generators 329 (see FIG. 3H) and stored in water tank 308, which is integrated to control flow and water production of the system. Water Tank 308 can be powered 110-240 Volts/alternating current (AC) at 35 Watts. Water is then provided, as input, to the one or more electrolyzers 300 via piping 320 to be used in the electrolysis process. In embodiments, the type of electrolysis performed depends on the type of electrolyzer unit 300, configured to perform either anion exchange electrolysis or proton exchange membrane electrolysis. The one or more electrolyzer units 300 output H₂ through one or more pressurized pipe and valve control systems 319 which provide the H₂ to one or more H₂ dryers 301 configured to remove moisture from the H₂. The one or more H₂ dryers 301 are configured to output dried H₂ to either, or both, of storage containers or tanks 303 configured to store H₂ for future use, or compressor 305 (see FIG. 3D) configured to compress H₂ for delivery as fuel to one or more devices. In embodiments, the one or more H₂ dryers 301 are a hybrid temperature/pressure swing adsorption system that utilizes cartridges filled with a highly adsorbent material. The one or more H₂ Dryers 301 are maintenance free during operation as one cartridge is used to remove humidity from the hydrogen gas stream of the electrolyzer 300, while the other cartridge is heated and regenerated. The regeneration process can then be reversed to clear the full cartridge. In embodiments, a controller 312 can include one or more electronic or electromechanical components configured to control inputs, outputs, and functionality of the OSP.

Advantageously, based on operating conditions, OSP is capable of producing 1 kg of H₂ over a 24 hr period. Based on available power, operating conditions, and configuration of the OSP, the production rate can vary from 1 to 20 kg during a 24-hr. period. The OSP can support fuel cells rated from 1 kW to 30 kW. The purity of H₂ generation for this system is 99.97% or better at 35 barg output pressure or, in some cases, at ˜2 barg output pressure.

FIG. 3B illustrates a Reformer 302 H₂ Generation OSP (H₂-OSP-R1/2) including a Reformer 302, such as a Methanol reformer, mounting cage(s), H₂ dryer 301, electrical wiring 317 using hardened connectors for power and control signals, associated piping 320, Feedstock Fuel Tank 315 with fuel pump 316 and in some embodiments a buffer tank 321 with an electronic tank valve atop or beside the tank 321.

In embodiments, Feedstock fuel tank 315 can include a Hydrogen source such as a hydrocarbon fuel source, or alcohol fuel. In embodiments, fuel tank 315 can have a capacity of 50 gallons, or more. In embodiments, the Hydrogen source can be a mixture of Methanol (MeOH) and distilled water. In a preferred embodiment, the Hydrogen source is a mixture of 62% MeOH and 38% distilled water. Fuel pump 316 can provide Hydrogen source to reformer 302. The Reformer 302 can separate H₂ from the mixture utilizing a catalyst as known in the art. The reformer 302 may be contained within a controlled environment, controlling airflow, for example. In embodiments, Reformer 302 can provide the H₂ to one or more H₂ dryers 301 configured to remove moisture from the H₂. The one or more H₂ dryers 301 are configured to output dried H2 to either, or both, storage containers 303 configured to store H₂ for future use, or compressor 305 (see FIG. 3D) configured to compress H₂ for delivery as fuel to one or more devices. In embodiments, the one or more H₂ dryers 301 are a hybrid temperature/pressure swing adsorption system that utilizes cartridges filled with a highly adsorbent material. The one or more H₂ Dryers 301 are maintenance free during operation as one cartridge is used to remove humidity from the hydrogen gas stream of the Reformer 302, while the other cartridge is heated and regenerated. The regeneration process can then be reversed to clear the full cartridge. In some embodiments, the Buffer Tank 321 has a manual bypass valve to support varying H₂ input volumes across compression means. Multiple Reformer units 302 can be integrated to produce larger quantities of H₂ and support larger power needs. In one embodiment, Reformer 302 can provide up to 130 Standard Liters per Minute (sLm) of hydrogen or approximately 18 kg H₂ per 24-hrs of operation. In another embodiment, Reformer 302 can provide up to 3,000 sLm of hydrogen or approximately 390 kg per 24-hrs of operation.

FIG. 3C1 illustrates storage and output components of a reformer 302, including a Main storage tank 303 with control valves 319, type 3 and/or Materials Based Non-Pyrophoric H₂ Storage Tanks, mounting cage(s), electrical wiring 317 using hardened connectors for power and control signals, and associated piping 320 to capture the output of H2 Generation systems and provide feedstock for the H2 Fueling OSP (see FIGS. 3E and 3F) and/or Fuel Cell 311 OSP. A Type 3 Buffer Tank 321 supports up to 1 kg of H₂ at 35 barg and is used to capture the output of the H₂ from reformer 302. The contents of the Buffer Tank 321 are then sent to the compression system (see FIG. 3D) and fed to the Main Storage Tank 303. Multiple Main Storage Tanks 303 can be combined via a Manifold System 318 to support storage of large quantities of H₂.

In some embodiments, the Main Storage Tank 303 is a Type 3 Tank for compressed gaseous storage and supports from 1 to 4 kg of H₂ at 350 barg (5,000 psi) with increased amounts for a 700 barg (10,000 psi) tank.

In other embodiments, the Main Storage Tank 303 uses Materials Based Non-Pyrophoric Tanks for “solid” storage of 1 to 3 kg of H₂ at 17-35 barg (250-500 psi).

FIG. 3C2 depicts an H₂ Electrolyzer(s) 300 (see FIG. 3A) and/or an H₂ Reformer(s) 302 (see FIG. 3B) with a H₂ Type-3 Tank storage system 303 (H₂-OSP-S1) which may have an electronic tank valve at one end, the H₂ Compressor 305 System (see FIG. 3D), and the Fueling System (see FIGS. 3E and 3F). In embodiments, the system can include at least one Electrolyzer 300, reformer 302, or a combination thereof, configured to produce H₂. H₂ produced can be transmitted through one or more manifolds 318 and/or control valves 319 to buffer tank 321, and/or directly to the H₂ type-3 Tank storage system 303. In some embodiments, the buffer tank 321 can be configured to store H₂ to vary input flows into H₂-type 3 tank storage system 303. Pneumatic power system 307 can provide compressive force to compress air in tank 324, which is configured to provide compression for H₂ into H₂ type 3 tank storage system 303 and for use in refueling operations. In embodiments, control for all components of the system is provided by element management system (EMS) 312. In embodiments, refueling panel 304 can be configured to monitor pneumatic pressure, H₂ inlet pressure, H₂ outlet pressure (i.e. fueling pressure), and can include a vent system, an inlet valve and an outlet valve. In embodiments, a device needing refueling can be connected to an outlet valve where H₂ fuel can be provided to the device.

FIG. 3C3 depicts an H₂ Electrolyzer 300 (see FIG. 3A) and/or H₂ Reformers 302 (see FIG. 3B) with the H₂ Non-Pyrophoric Tank storage system (H₂-OSP-S2) 303 connected directly to the Fueling System (see FIGS. 3E and 3F) as no Main Tank Compression is required. In embodiments, the system can include at least one Electrolyzer 300, reformer 302, or a combination thereof, configured to produce H2. H2 produced can be transmitted through one or more manifolds 318 and control valves 319 directly to H₂ pyrophoric tank storage system 303, as no main tank compression is required. In some embodiments, buffer tank 321 can be configured to store H₂ to vary input flows into H₂ inlet of fueling system 304.

FIG. 3D illustrates a H₂ Compression system comprising a compressor 305, mounting cage(s), control valves 319, electrical wiring 317, and associated piping 320. The compression system receives H₂ as input from H₂ buffer tank 321 and pneumatic pressure from pneumatic power system 307. H₂ is fed through piping 320 which includes a number of relief valves, pressure regulators, and pressure gauges disposed between the input and compressor 305. Compressor 305 utilizes pneumatic pressure from pneumatic power system 307 to compress H₂ and the compressed H₂ to H₂ main storage tank 303. In an alternative embodiment, an electrically driven compressor using AC or DC power from the platform's Electrical Power System can be used. Compressor 305 supports outlet pressures of 350 barg (5,000 psi) to 700 barg (10,000 psi). This system also provides for low pressure fueling to 1 bar using pressure reducers and regulators. Additionally, the output of compressor 305 includes a number of components including a pressure regulator, a pressure gauge, and an emergency shutoff valve disposed between the output of compressor 305 and the input to H₂ main storage tank 303. EMS 312 is configured to control elements of the compression system. The components can be mounted and plumbed in an open frame steel rack with a sloped front control panel containing the valves, gauges and analog/digital controls 110 required for safe use. The system supports safety mechanisms controlled by the platform's EMS 312 to prevent overpressure/overfilling of tanks that are connected to the compression system.

FIG. 3E depicts a H₂ Fueling System comprising a compressor 305, mounting cage(s), control valves 319, electrical wiring 317, and associated piping 320.

The H₂ fueling system can be scaled to fuel small systems such as Unmanned Aerial Vehicles (UAV) as well as larger H₂ Fuel Cell Vehicles. The system uses Booster Compression Fueling to enable tight control of tank pressure, reduce residual hydrogen in the container, and provide the high outlet pressures required for some systems. Outlet pressure will vary from 35 barg to 700 barg.

In embodiments, H₂ can be provided as input to system compressor 305 through H₂ main tank 303, via one or more of piping 320. In embodiments, piping 320 can be disposed between a plurality of pressure regulators, relief valves, pressure gauges, valves, vents and/or bypass valves. For example, excess hydrogen exiting the system may be vented. In embodiments, compressor 305 is driven by the Pneumatic Power System 307 (see FIG. 3G). As an alternative, an electrically driven compressor using AC or DC power from the platform's Electrical Power System is used. In embodiments, H2 can be dispensed via a nozzle controlled by a smart valve which regulates the flow rate of the gas to fill an H₂ fuel tank to the required pressure in accordance with the correct fueling protocol set in the platform's EMS 312. A bypass system is also part of the fueling system to allow low pressure operations via manual methods.

FIG. 3F illustrates a man portable H₂ Fueling system for use at remote locations or under emergency conditions without the need for movement of the H₂ fueling platform. The system comprises an H₂ Cylinder 323, Compressed Air Cylinder 322, Manual Fueling Control System 312, an H₂ Compression system 325, and associated piping 320.

In embodiments, inputs to the system can include H₂ from one or more H₂ cylinders 323 and pneumatic pressure from compressed air cylinder 322, and outputs to the system can include H2 fuel for use at remote locations or under emergency conditions without the need for movement of the H₂ fueling platform. In embodiments, H₂ can be provided as pressurized fuel through one or more H₂ compression systems 325. In embodiments, H₂ is fed through piping 320 which includes a number of relief valves, pressure regulators and pressure gauges disposed between the input and compressor 305. Additionally, piping from the compressor 305 can include one or more pressure regulators, pressure gauges, vents, and/or valves.

The portable H₂ Cylinder 323 is charged with 1 kg of H₂ at 350 barg (5,000 psi) using the main fueling system H₂ Compression OSP (see FIG. 3D). The Compressed Air cylinder 322 is compressed to 100 psi using the main fueling system Air Compression OSP (see FIG. 3G). The Manual Fueling Control System and the H₂ Compression System are mounted in a (2) person common carrying case 326. The system uses hardened flexible hoses 320 to connect the system to the portable cylinders and the device to be fueled.

FIG. 3G depicts a Pneumatic Power System (H₂-OSP-A) 307. In embodiments, system 307 can include at least one air filter 102, at least one compressor 305, at least one moisture separator 327, at least one air tank 324, mounting cage(s), control valves, electrical wiring 317, and associated piping 320. The main function of system 307 is to power the platform's compressor systems.

In embodiments, the system 307 outputs pressurized air for utilization in compression of H2 and/or fueling operations, as well as for any pneumatic device. In embodiments, ambient air can be routed to at least one compressor 305 through at least one air filter 102 and electrical power may be routed to the at least one compressor 305 from an AC or DC power source. In embodiments, the at least one air filter 102 can be piped in parallel. The compressor 305 may be operated with an electric motor, for example. In embodiments, ambient air compressed by at least one compressor 305 can be routed through one or more moisture separators 327 before arriving at least one air tank 324 for storage. In embodiments, compressed air can be provided from at least one air tank 324 to an output through at least one air filter. In embodiments, one or more valves, traps, gauges, regulators and/or vents can be disposed between an input of the plurality of components and the output.

System 307 can provide approximately 7 sLm at up to 600 psi maximum and can be powered via DC or AC power. In embodiments the at least one air tank 324 can be a Type 3 Tank with appropriate electronic control valve 319 to manage charging and discharging of the system. The system 307 monitors tank pressure to ensure an operational reserve is maintained for the system by controlling operations of the compressor 305 using a combination of pressure sensors and control relays 328. Additionally, system 307 can be controlled by EMS 312. Safety valves are used to ensure system pressure limits are not exceeded.

FIG. 3H illustrates a Water Generation System (H₂-OSP-W) including an Atmospheric Water Generator (AWG) 329, a Water Storage Tank 308, and Water Filter 330. In embodiments, AWG 329 can receive ambient air through one or more air filters 102. In embodiments, AWG 329 can utilize ambient air to generate water. Specifically, AWG 329 can generate 5 Gallons of Deionized Water over a 24 hr period at 80% Relative Humidity/75° F. Minimum operational conditions of AWG 329 are 40% Relative Humidity and 50° F. AWG 329 can be powered at 24 Volts direct current (VDC) at 10 A. Additional deionized water can be provided by water filter 330 which is configured to deionize water provided from a municipal water supply. The water filter 330 cleans water from a local source to make it usable in the Anion Exchange Membrane (AEM) Electrolyzer using a series of replaceable filters. Deionized water can be provided to an H2 electrolyzer 300 tank selectably through at least one water manifold valve configured to select between AWG 329 and Water filter 330. In some embodiments, the system can provide potable water as an output through tank 308. A Mineralization Filter 331 may provide minerals and other necessary materials to make the Deionized Water suitable for human consumption.

FIG. 3J depicts a Renewable Energy System 309 (H₂-OSP-E). System 309 can include a PV System 332, Wind Turbine 333, PV Deployable Mounts, Fixed Wind Turbine Mount 334, Free Standing Wind Turbine Mount 335, control system, and electrical wiring to generate electrical power needed for operation of the overall platform.

In embodiments, the solar or PV system 332 comprises from about 9 to 18 photovoltaic panels and can be configured to generate 550 W per panel, utilizing the Hybrid Inverter 313 found in the Element Management System 312 (see FIG. 3L) for connectivity and control. The Deployable PV 332 system provides 1 kW to 12 kW of DC power. Multiple PV systems may be combined to provide high power output as required. In some embodiments, the system 309 utilizes an integrated mounting system for the panels that utilizes a combination of sliding and folding mechanisms for deployment of the panel array. In some embodiments, the PV system is flexible and can be rolled up and stored on the trailer for movement.

Advantageously, the PV system 332 of the present invention may deploy hardened solar panels on the side of the trailer utilizing a roll-out mechanism.

The power and control wiring for the panels are integrated into the mounting system to allow faster deployment and to allow limited use of the PV array for charging during movement. The Wind Turbine 333 ranges in size from 1 kW to 20 kW and is mounted via a telescoping monopole mast 334. The monopole mast 334 can be mounted to the main structure 106 of the mobile unit or via separate tripod mount 335 that is stabilized via tether cables and ground stakes 336. The security wind speed of the wind turbine is 40 m/s (90 mph) or better. Startup wind speed is ˜1.3 m/s (2 mph). The Wind Turbine utilizes the Hybrid Inverter 313 found in the Element Management System 312 (see FIG. 3L) for connectivity and control via a combination power and control hardened cable system.

When required, the Renewable Energy system can be mounted on a separate mobile system to allow augmentation of the Electrical Storage System (Batteries) or to add external systems such as portable generators and additional fuel tanks.

FIG. 3K illustrates an Electrical Energy Storage (H₂-OSP-V) system with one or more power sources 306, 310, 311, one or more power management devices 337, at least one hybrid inverter 313, at least one direct current (DC)/alternating current (AC) inverter 313, at least one additional power source, and at least one breaker or power panel 338.

In embodiments, the one or more power sources 310 can be lithium iron phosphate or Lithium Ferrous Exide (LIFEPO₄) Batteries packs and/or Super Capacitor Packs and/or nickel hydrogen (Ni—H₂) Battery Packs for storage of on demand electrical energy. In embodiments, the system can provide from 100 Ah to 9,000 Ahs at 48 Volts DC (VDC) or 96 VDC. The power management device 337 may include a Battery Management System (BMS) for every battery/super capacitor pack that is responsible for operational control and to ensure prevention of thermal runaway and other OSP related safety protocols. The BMS system can be linked to the EMS 312 in order to balance charge and discharge cycles with the Renewable Energy 309 and grid/generator Volts AC (VAC) energy supplies 306. A Hybrid Inverter 313 found in the Element Management System 312 can be used for connectivity and control. A DC/AC Inverter 313 is provided to convert DC power from a Fuel Cell 311 System for use on the Hybrid Inverter 313. The Hybrid Inverter 313 also provides connectivity for a regulated Generator 306 connection to the Power System. An AC Breaker Panel 338 and a DC Power Panel 338 provide overload protection and power control to system components and external devices.

FIG. 3L depicts a Fuel Cell 311 OSP (H₂-OSP-FC) configured to utilize H₂ to produce DC Electrical Power. The system can include at least one fuel cell 311 which may be contained in a controlled environment, mounting cage(s), control valves 319, electrical wiring 317, and associated piping 320.

In embodiments, the at least one fuel cell 311 can range in output from 4 kW to 30 kW and can be combined in various configurations to provide the required power output. The at least one fuel cell 311 can be powered by DC and/or AC power provided by the platform's electrical power system. In embodiments, H₂ consumption ranges from 17 g to 70 g per kWh and can be provided through the system by a plurality of components such as relief valves, pressure regulators, pressure gauges, etc. disposed between the input and output of the system. Based on multiple factors, a liquid cooling system with an external radiator is provided for cooling of the fuel cell 311 system. Fuel Cell output voltage ranges from 48 VDC to 400 VDC and is managed by a DC/DC inverter 313 integrated with an EMS 312. In embodiments, air filters can be provided with each of the at least one fuel cell 311. In embodiments, H₂ fed from an input tank 303 can be directed to the at least one fuel cell 311 by a manifold 318 (not labeled). DC power can be provided by the at least one fuel cell 311 to at least one VDC circuit breaker (not labeled) configured to protect electrical circuits. In embodiments, DC power can be provided as output via at least one bus bar. The system can interface with and may be controlled by the EMS (see FIG. 3L) 312 using Controller Area Network (CAN)/Recommended Standard (RS)-485 communication protocols via wired and wireless network interfaces.

FIG. 3M illustrates an Element Management System (H₂-OSP-EMS) 312 which comprises the hardware and software tools used to integrate energy devices into a unified energy network for systems of varying size and complexity. EMS 312 provides a comprehensive web and mobile app dashboard that provides operational understanding via analytics of the overall system and control of all connected devices. EMS 312 supports both wired and wireless communication for on-site and remote monitoring and control. EMS 312 supports Message Queuing Telemetry

Transport (MQTT) and ports 346 using industry standard protocols RS-485, CAN, Modbus, Simple Network Management Protocol (SNMP), and Hypertext Transfer Protocol (HTTP) as well as machine learning (ML)/artificial intelligence (AI) integrations.

EMS 312 utilizes Universal Control Modules (UCMs) 339 to provide connectivity to third-party devices (i.e., solar panels, wind turbines, hydrogen tanks, fuel cells, batteries, digital and analog sensors, etc.) by translating device protocols into a Unified Control Protocol (UCP) that is used by EMS 312. UCM(s) 339 receives measurement data and sends control commands to these third-party devices. UCM(s) 339 are interconnected by the Intelligent Gateway 340 (which may include an integrated inverter 313) via Ethernet Interfaces 344 as well as Bluetooth and Wi- Fi Wireless 345 interfaces.

EMS 312 also utilizes a Telemetry Platform (TP) 341 to collect data across system resources that are used by the Rules Engine (RE) 342 to build, maintain, run and check low-level commands to achieve operational objectives and high-level goals. If deviations are detected, customizable alerts (i.e. push notifications) keep the user informed to protect the energy system. RE 342 controls electrical components automatically or on demand, taking into account defined power configurations, operating conditions and history, and external data such as weather conditions and equipment specifications. Overall management of the system is via the ML/AI Integration 347. TP 341 sends data to a warehouse that can be provided on-site or in a private/public cloud 348 via the Intelligent Gateway 340.

EMS 312 also contains developer tools 343 to help external system integrators and component manufacturers integrate their systems into this platform. Developer tools 343 support automation features enabling full control over devices, workflows, and processes.

The EMS 312 also contains a Hybrid Inverter 313 for integration and control of Renewal Energy Systems (Solar/Wind), Batteries, Grid Power, and Generator Power. The inverter 313 supports a 5 ms or less transfer between power sources when power drops. The renewable energy interface supports 19 kW DC @ 26A coupling per Maximum Power Point Tracking (MPPT) interface for PV and Wind Turbine energy generation systems. MPPT maximum voltage input is 500 VDC. The inverter 313 provides a breaker system to support up to 19.2 kW generator input breaker as well as a 200 A passthrough breaker for connection to grid power. The inverter 313 also supports a 48 VDC Battery Charger with a capacity of 50 ampere hours (AH) to 9,000 AH. This same battery connection is used to power the system as required. The inverter 313 also supports the following control systems: CAN bus and RS-485 protocols, Battery temperature sensor, Battery Management System to control balancing and state of charge, support for LIFEPO4 and Super Capacitors storage systems, Wi-Fi interface, Auto Generator Start/Stop, Current Transformer Sensors, Automated Current Limiting, disconnect switches for use during servicing, and Emergency Stop and Rapid Shutdown. For larger applications, up to 5 inverters can be connected in parallel and control by designating one of the inverters as the master controller. The inverter 313 has an integrated touch screen for control of the overall power system as well as an application to provide this control via a remote wireless device.

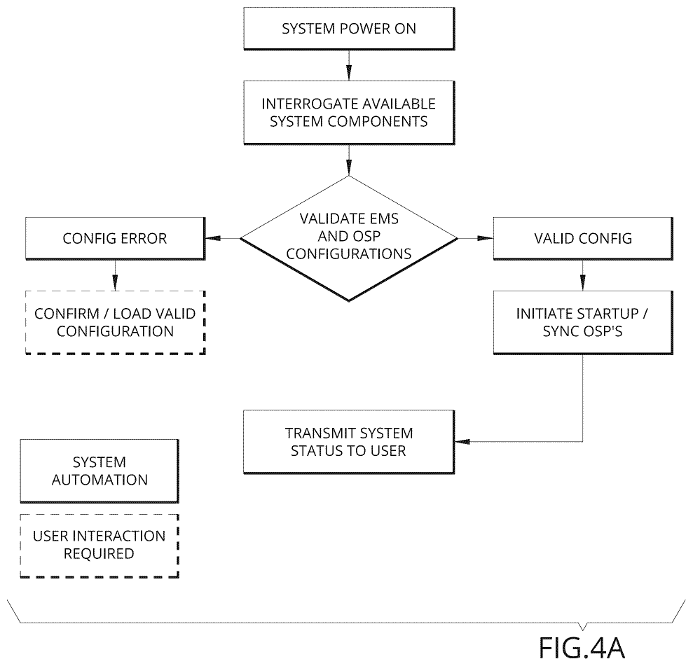

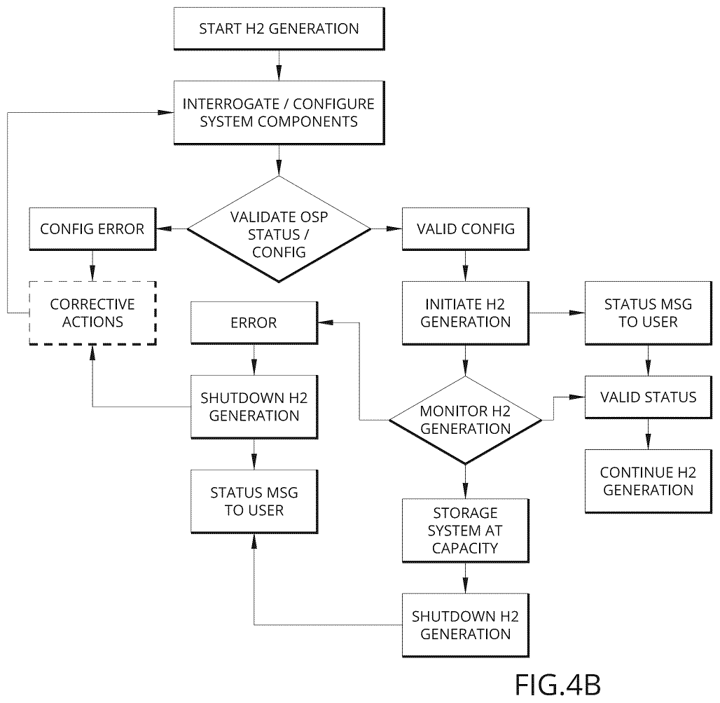

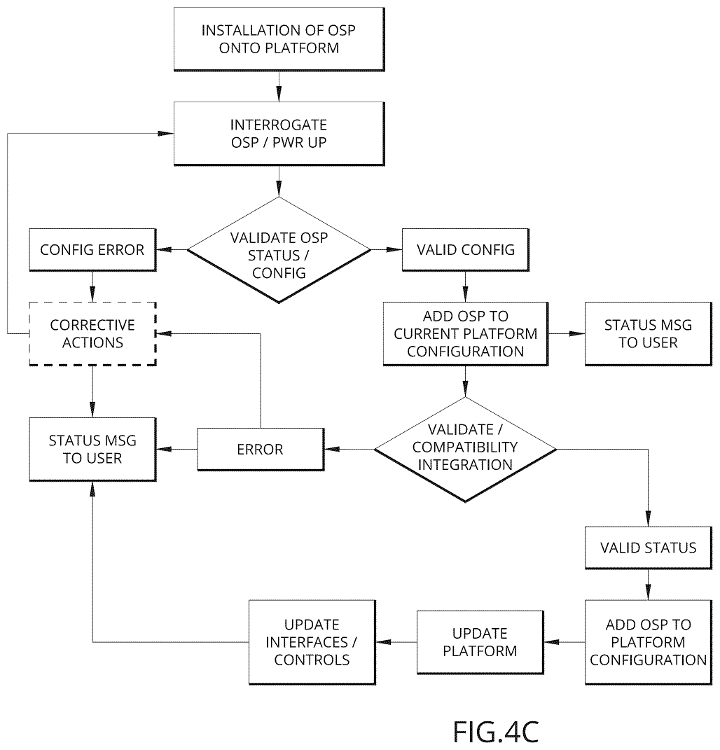

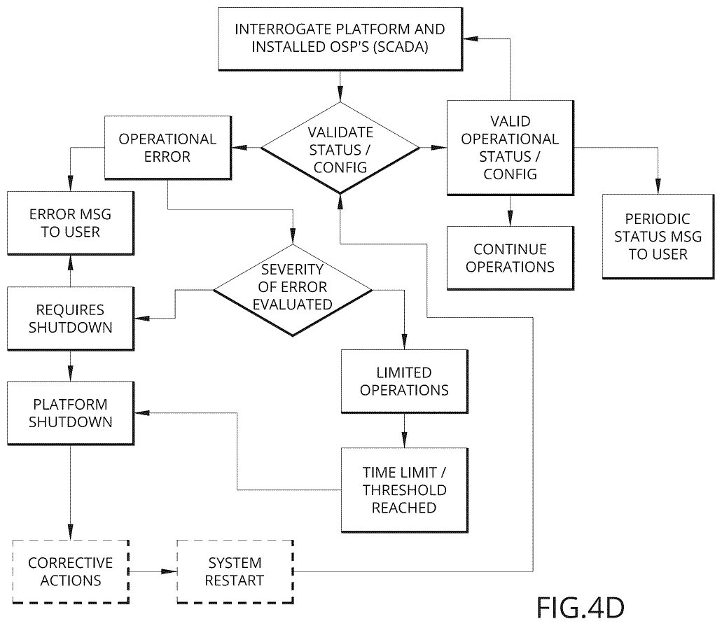

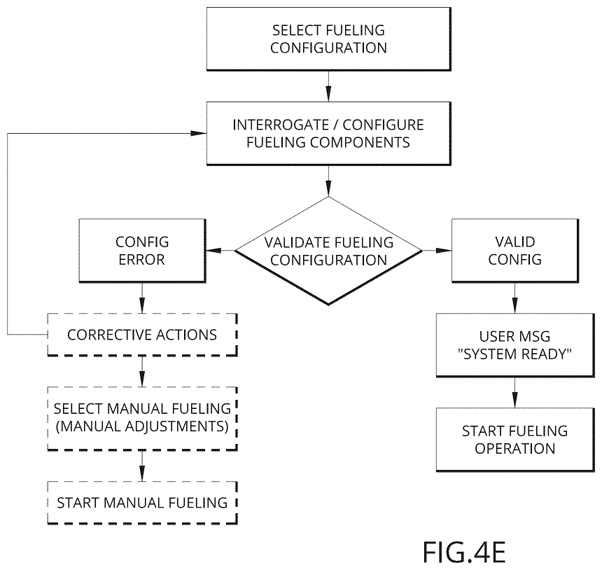

FIG. 4A depicts a startup sequence for the platform. When the system power is toggled on, the system interrogates the system components assembled on the platform and connected to the EMS and validates the OSP and EMS configurations are correct for the systems present. If valid, the EMS initiates the startup sequence for all OSP and synchronizes their state and data with the EMS. The EMS then transmits a status message to the user to indicate the system is powered up and operational. Should the system discover a configuration error on any of the attached OSP or the platform/EMS configuration, the system will not power up the OSP and will issue an error message to the USER requesting manual intervention to correct the configuration error. Once the error is corrected, the system will restart the process.

FIG. 4B illustrates an H₂ Generation process. The control panel is used to start the generation of H₂. The system will validate the OSP and configurations present. If there is a valid configuration present, the H₂ generation process will start, and a status message is sent to the user. As the generation process continues, the EMS will monitor the process using the Telemetry system and the Rules system. Should an error be detected in the process, the H₂ Generation process is shut down by the EMS and a fault message is sent to the user along with a request for manual intervention. Once the fault is cleared, the process starts over again with the interrogation step. Once the storage system reaches its capacity, the H₂ Generation process is shut down and the status message is sent to user notifying them the storage means is full. As the H₂ is utilized, the storage system will notify the EMS that additional H₂ is required, the H₂ Generation process will automatically start again. The H₂ Generation process can be stopped via the control panel and all automated processes will stop.

FIG. 4C illustrates a process of adding an OSP to the platform. The User will install the OSP and make the proper connection. The user will then power the OSP and which time the EMS will interrogate the newly discovered OSP and validate its configuration and status. If the OSP is valid, the EMS will add the newly installed OSP to the system and then validate its compatibility with the current platform configuration. If the compatibility is validated, the EMS will add the new OSP to the platform configuration, update user interfaces and control, and configure other OSP to interact with the new OSP. A message will be sent to the user that the new OSP has been successfully added to the platform. If there is an error at any one of the validation steps, an error/fault message will be sent to the user requesting manual intervention to correct the error/fault.

FIG. 4D depicts a Supervisory Control and Data Acquisition (SCADA) safety system used on the platform. The SCADA system will always run no matter what the status of the OSP or the overall platform is at any time. If the SCADA sees no operational faults, it will continue the cycle at an interval set by the user or at the system's default cycle timing. A periodic status message will also be sent to the user. If an operational error/fault is detected, the severity of the error/fault is evaluated. If it is a server error/fault, the platform will be shut down immediately and a Warning/Safety message will be sent to the user requesting immediate intervention and corrective measures. Once the corrective measures are taken by the user, the user will initiate the startup process found in FIG. 4A.

FIG. 4E depicts a fueling process. When the fueling process is selected, the system interrogates the fueling process-associated OSPs and the current fueling configuration. The system then validates the configuration. If no error is found, the system messages the user that the system is ready for fueling and displays the current setting at the fueling cabinet. If the settings meet selected requirements for this fueling action, the user makes the proper connections and presses the start button. The user can then change any setting required and continue the fueling process. If an error is found, the system does not allow fueling and requests corrective action be taken by the user. The user may bypass the fueling process and manually fuel a device. The fueling process ends when the fueling settings are achieved or when the user presses the manual stop button.

It should be understood, of course, that the foregoing relates to exemplary embodiments of the invention and that modifications may be made without departing from the spirit and scope of the invention as set forth in the following claims.

What is claimed is:

1. A modular mobile hydrogen generation platform, comprising:
a frame;
a hydrogen generator mounted within the frame, wherein the hydrogen generator is selected from the group consisting of one or more electrolyzers;
one or more reformers; and any combination thereof;
a hydrogen storage system mounted within the frame and fluidly communicating with the hydrogen generator and configured to receive hydrogen generated by the hydrogen generator;
a pneumatic power system mounted within the frame;
an electrical power source mounted within the frame and electrically coupled to the hydrogen generator; and
a controller.

2. The modular mobile hydrogen generation platform of claim 1, wherein the frame is mounted on a trailer, the trailer having a towing connector and retractable stabilization mechanisms mounted thereon.

3. The modular mobile hydrogen generation platform of claim 2, wherein the trailer further comprises an enclosure housing the frame, the enclosure having a filtered air inlet.

4. The modular mobile hydrogen generation platform of claim 1, wherein the frame is housed within an intermodal container.

5. The modular mobile hydrogen generation platform of claim 1, wherein the hydrogen generator includes the one or more electrolyzers, with each electrolyzer containing a membrane selected from the group consisting of a proton exchange membrane and an anion exchange membrane.

6. The modular mobile hydrogen generation platform of claim 1, further comprising a water tank fluidly communicating with the hydrogen generator; and an atmospheric water generator fluidly communicating with the water tank.

7. The modular mobile hydrogen generation platform of claim 1, wherein the electrical power source is selected from the group consisting of an electric generator; at least one battery; at least one supercapacitor; a fuel cell; at least one photovoltaic panel; a wind turbine; and any combination thereof.

8. The modular mobile hydrogen generation platform of claim 1, further comprising a renewable energy module mounted to the frame, the renewable energy system comprising a photovoltaic panel assembly and/or a wind turbine.

9. The modular mobile hydrogen generation platform of claim 1, further comprising a fueling module mounted to the frame, the fueling module comprising:
a compressor coupled to the pneumatic power system and fluidly communicating with the hydrogen storage system; and
a regulated fuel outlet fluidly communicating with the compressor.

10. The modular mobile hydrogen generation platform of claim 1, wherein the controller comprises a universal control module; an intelligent gateway; a telemetry platform; a processor with a rules engine with artificial intelligence integration; and an electronic interface.
